(19) United States
(12) Patent Application Publication
(10) Pub. No.: US 2004/0098879 A1
(43) Pub. Date: May 27, 2004

(54) Laundry drier and control method thereof

(76) Inventor: Gi Hyeong Do, Changwon-si (KR)

Correspondence Address: MCKENNA LONG & ALDRIDGE LLP, 1900 K STREET, NW, WASHINGTON, DC, 20006, US

(21) Appl. No.: 10/716,444

(22) Filed: Nov. 20, 2003

(30) Foreign Application Priority Data
Nov. 26, 2002 (KR) P 2002-0074061

(51) Int. Cl. F26B 11/02

(52) U.S. Cl. 34/595

(57) ABSTRACT

A laundry drier and control method thereof are provided, by which a cooling procedure is completed by sensing when an internal temperature drops below a predetermined temperature. The laundry drier includes a temperature sensor for sensing an internal temperature of the laundry drier and outputting a sensed temperature signal indicative of the internal temperature; and a microcomputer for controlling drivers for driving a heater, motor and exhaust fan according to the sensed temperature signal from the temperature sensor. The method of controlling a laundry drier includes steps of performing a cooling procedure; sensing an internal temperature of the laundry drier during the cooling procedure performing step; comparing the sensed internal temperature with a predetermined temperature value; and stopping the cooling procedure performing step if the sensed temperature is lower than a predetermined temperature.

This application claims the benefit of Korean Application No. 10-2002-0074061 filed on Nov. 26, 2002, which is hereby incorporated by reference.

### BACKGROUND OF THE INVENTION

1. Field of the Invention

The present invention relates to a laundry drier, and more particularly, to a laundry drier and control method thereof, in which a temperature sensor is employed to enable a dynamic adjustment of cooling time after completion of a drying procedure.

2. Discussion of the Related Art

A laundry drier is an apparatus for drying wet objects, e.g., clothes, after completion of a washing cycle or the like. FIGS. 1 and 2 illustrate a laundry drier according to a related art, with FIG. 2 showing a cross-section taken along a line I-I in FIG. 1.

Referring to FIGS. 1 and 2, a drier according to a related art is comprised of a body 100 having an entrance 101 at a front side in which a door 105 is installed, a drum 30 rotatably installed in the body and having a plurality of stirrers 30a protruding from an inner circumferential surface of the drum, a motor 50 fixed to an inner side surface of the body to generate and transfer via a belt 60 a slow and directionally controllable rotational force with respect to the drum, first and second hot air passages 10a and 10b for guiding an air flow of external air (10a) to drum's interior to be discharged (10b) to the exterior of the laundry drier, a heater 20 installed inside the first hot air passage to heat the air therein, and an exhaust fan 40 for generating a forcible blowing force to discharge air through the second hot air passage and thereby draw in external air through the first hot air passage.

In the operation of the above-constructed laundry drier according to the related art, with wet laundry placed in the drum 30, drying is initiated to actuate each of the exhaust fan 40, the heater 20, and the motor 50. As the exhaust fan 40 starts to operate, external air is drawn in through the first hot air passage 10a, where it is heated by passing through the heater 20 and forcibly led into the drum 30, to evaporate the water content of laundry placed therein. Thus, the drying action is realized by a negative blowing force of the exhaust fan 40, whereby a circulation of air is achieved by drawing in external air through the first hot air passage 10a and discharging the air through the second hot air guide passage 10b. Meanwhile, the drum 30 is rotated according to a predetermined cycle, and the stirrers 30a pull the laundry up one side of the drum's interior to fall back down into a lower area thereof. The laundry is dried through the above-explained process.

As drying thus proceeds, if a predetermined time has passed, the heater 20 and motor 50 are stopped. Here, the exhaust fan 40 continues to operate for a fixed predetermined time of say, five minutes, to perform a cooling of the interior of the laundry drier, after which the door 105 may be opened. Thus, the cooling is performed according to a procedure similar to that for drying, in which a constant operation is continued for a fixed duration.

As above, the laundry drier of the related art completes its assigned task by execution according to a predetermined time. That is, the cooling procedure is performed for a fixed time, as set by the manufacturer, regardless of the drier's internal temperature achieved during the drying procedure or the heat-retention properties of the drying object, i.e., laundry, which may vary according to a user command or based on the amount or type of laundry being dried. Therefore, cooling may be incomplete, such that it is unsafe to open the door, or may be excessive, such that time and energy are wasted.

### SUMMARY OF THE INVENTION

Accordingly, the present invention is directed to a laundry drier and control method thereof that substantially obviates one or more of the problems due to limitations and disadvantages of the related art.

An object of the present invention, which has been devised to solve the foregoing problem, lies in providing a laundry drier and control method thereof, by which a cooling procedure is completed by sensing when an internal temperature drops below a predetermined temperature.

It is another object of the present invention to provide a laundry drier and control method thereof, enabling a consistently safe operation of the door.

It is another object of the present invention to provide a laundry drier and control method thereof, by which time and energy can be conserved.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a laundry drier comprising a temperature sensor for sensing an internal temperature of the laundry drier and outputting a sensed temperature signal indicative of the internal temperature; and a microcomputer for controlling a plurality of drivers for driving a heater, motor and exhaust fan according to the sensed temperature signal from the temperature sensor.

In another aspect of the present invention, there is provided a method of controlling a laundry drier. The method comprises steps of performing a cooling procedure; sensing an internal temperature of the laundry drier during said cooling procedure performing step; comparing the sensed internal temperature with a predetermined temperature value; and stopping the cooling procedure performing step if the sensed temperature is lower than a predetermined temperature.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a laundry drier according to a related art;

FIG. 2 is a cross-sectional view along a line I-I in FIG. 1;

FIG. 3 is a block diagram of a laundry drier according to the present invention; and

FIG. 4 is a flowchart of a method of controlling cooling time in a laundry drier according to the present invention.

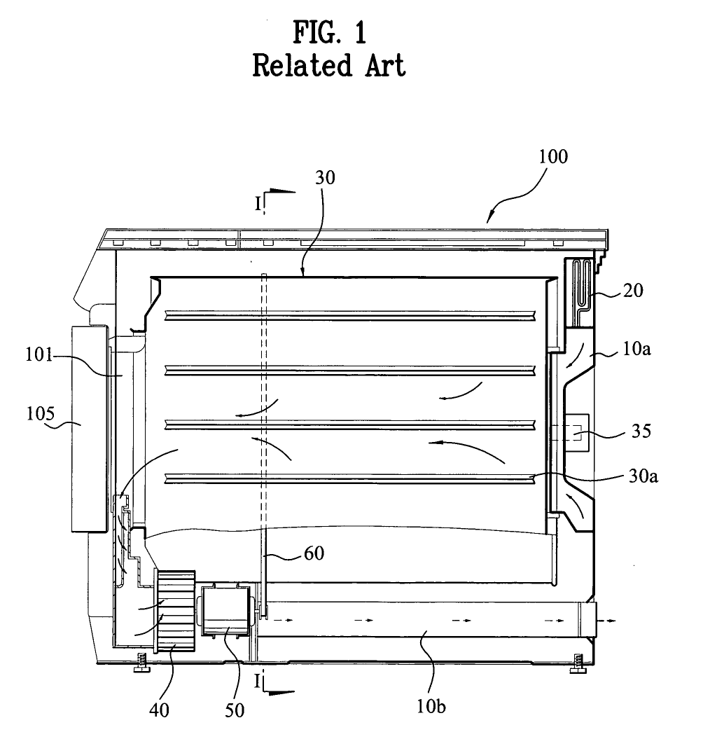

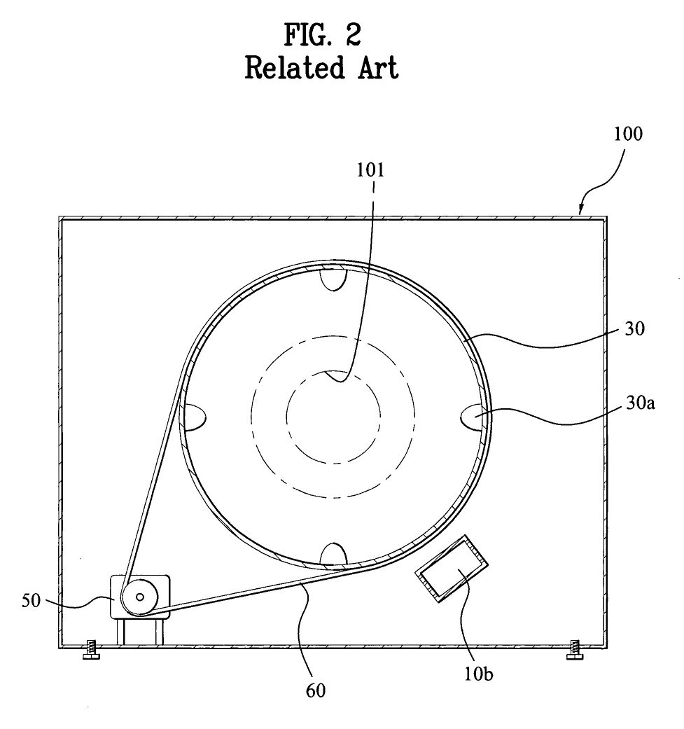

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

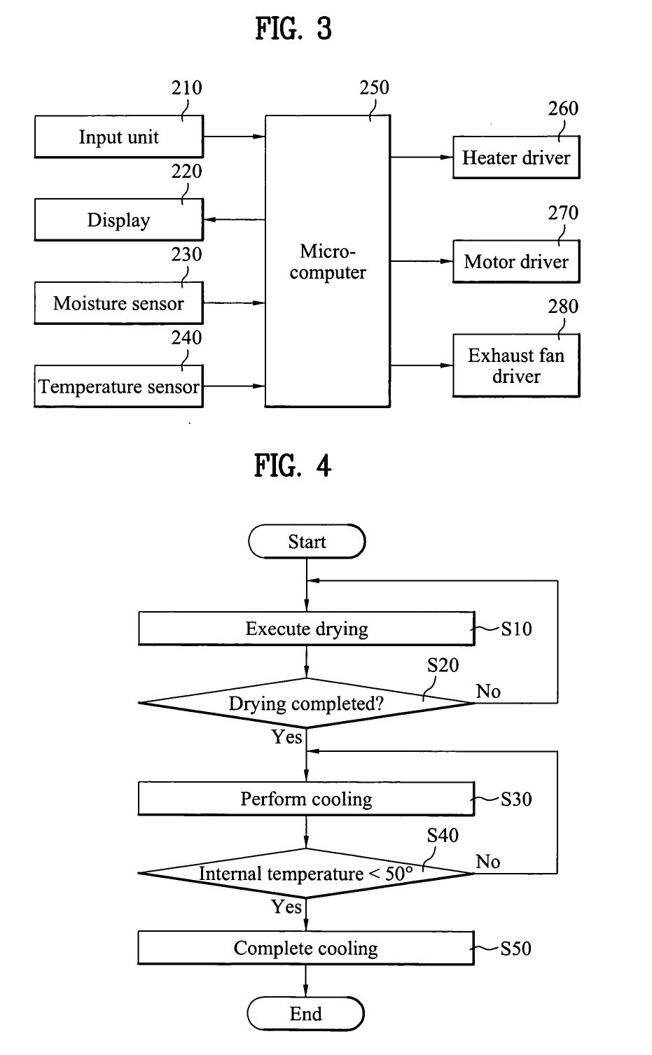

Referring to FIG. 3, a laundry drier according to the present invention is comprised of an input unit 210 for inputting user commands, a display 220 for displaying the respective operational states of drying and cooling procedures based on the input user commands, a moisture sensor 230 for measuring the water content of laundry during the drying procedure and for outputting a sensed water content signal, a temperature sensor 240 for detecting an internal temperature during the drying and cooling procedures and for outputting a sensed temperature signal, a microcomputer 250 for controlling the drying and cooling procedures based on the sensed signals and user command input, to determine the state of the drying procedure and to control accordingly each of heater, motor, and exhaust fan drivers 260, 270, and 280. The microcomputer 250 receives input signals from the moisture and temperature sensors 230 and 240 to assess drying and controls the heater and motor drivers 260 and 270 accordingly, by comparing the internal temperature with a predetermined temperature value.

Specifically, the temperature sensor 240 senses the temperature inside the laundry drier over the course of the drying procedure, i.e., while the heater, motor, and exhaust fan drivers 260, 270, and 280 operate. In addition, the temperature sensor 240 also senses the temperature inside the laundry drier during the cooling procedure, i.e., while the exhaust fan driver 280 continues to operate after the heater and motor drivers 260 and 270 stop operating. The sensed signals are output to the microcomputer 250. When the drier's internal temperature drops below a predetermined temperature of, say, 50° C., the microcomputer 250 outputs a “cooling complete” status signal to the display 220, to notify the user that the door is safe to open, thereby completing the cooling procedure.

Referring to FIG. 4, illustrating a laundry drier control method according to the present invention, where a drying object is placed inside the laundry drier, a drying procedure is executed in a step S10, to actuate the heater, motor, and exhaust fan drivers 260, 270, and 280 to dry the drying object. Thereafter, the completion of the drying procedure is determined in a step S20.

Upon completion of the drying procedure, the cooling procedure is performed in a step S30. That is, the microcomputer 250 controls the heater and motor drivers 260 and 270 to stop operating, and the temperature inside the laundry drier is sensed. The cooling procedure continues while sensing the drier's internal temperature. If it is determined in a step S40 that the sensed internal temperature has dropped below the predetermined temperature, the drying procedure is completed in a step S50, whereby the microcomputer 250 stops the operation of the exhaust fan driver 280 and controls the display 220 accordingly. To assist drying, the motor driver 270 may continue for a time during the cooling procedure.

Therefore, in the above laundry drier control method of the present invention, the cooling time is shorter in the event of drying a small amount of laundry or laundry having lower heat-retention properties and is increased in the event of drying a large amount of laundry or laundry having high heat-retention properties. Hence, the cooling time depends on the type and amount of the drying object in the drier.

As described above, the laundry drier and control method thereof according to the present invention enables a dynamic control of the cooling time using the drier's internal temperature instead of a fixed time, thus enabling a consistently safe operation of the door and preventing and an unnecessary waste of time and energy.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A laundry drier comprising:
a temperature sensor for sensing an internal temperature of the laundry drier and outputting a sensed temperature signal indicative of the internal temperature; and
a microcomputer for controlling a plurality of drivers for driving a heater, motor and exhaust fan according to the sensed temperature signal from said temperature sensor.

2. The laundry drier as claim in claim 1, wherein said microcomputer controls the plurality of drivers by comparing the sensed internal temperature with a predetermined temperature value.

3. The laundry drier as claim in claim 2, wherein the predetermined temperature value corresponds to an internal temperature of 50° C.

4. The laundry drier as claim in claim 1, wherein the sensed temperature signal indicates the internal temperature of the laundry drier during a cooling procedure.

5. The laundry drier as claim in claim 4, wherein the heater and motor are stopped and the exhaust fan is driven.

6. The laundry drier as claim in claim 4, wherein the heater is stopped and the motor and exhaust fan are driven.

7. The laundry drier as claim in claim 1, wherein the sensed temperature signal indicates the internal temperature of the laundry drier during a drying procedure.

8. The laundry drier as claim in claim 7, wherein the heater, motor, and exhaust fan are driven.

9. A method of controlling a laundry drier, comprising steps of:
performing a cooling procedure;
sensing an internal temperature of the laundry drier during said cooling procedure performing step;
comparing the sensed internal temperature with a predetermined temperature value; and
stopping said cooling procedure performing step if the sensed temperature is lower than a predetermined temperature.

10. The method as claim in claim 9, wherein the predetermined temperature value corresponds to an internal temperature of 50° C.

11. The method as claimed in claim 9, further comprising steps of:
performing a drying procedure; and
sensing an internal temperature of the laundry drier during said drying procedure performing step.
